(19) United States
(12) Patent Application Publication
(10) Pub. No.: US 2003/0185275 A1
(43) Pub. Date: Oct. 2, 2003

(54) Method and assembly for the multi-channel measurement of temperatures using the optical detection of energy gaps of solid bodies

(76) Inventors: Claus Peter Renschen, Dresden (DE); Ulf Roland, Leipzig (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/296,971

(22) PCT Filed: May 23, 2001
(86) PCT No.: PCT/EP01/05951

(30) Foreign Application Priority Data
Jun. 2, 2000 (DE) 100 27 533.8

(51) Int. Cl. G01J 5/08

(52) U.S. Cl. 374/130

(57) ABSTRACT

The invention relates to a process and an arrangement for temperature measurement by means of optical detection of energy band gaps of solids with electrical light sources, measurement probes and a wavelength-sensitive detection system that measures the frequency of the light guided back by the measurement probe.

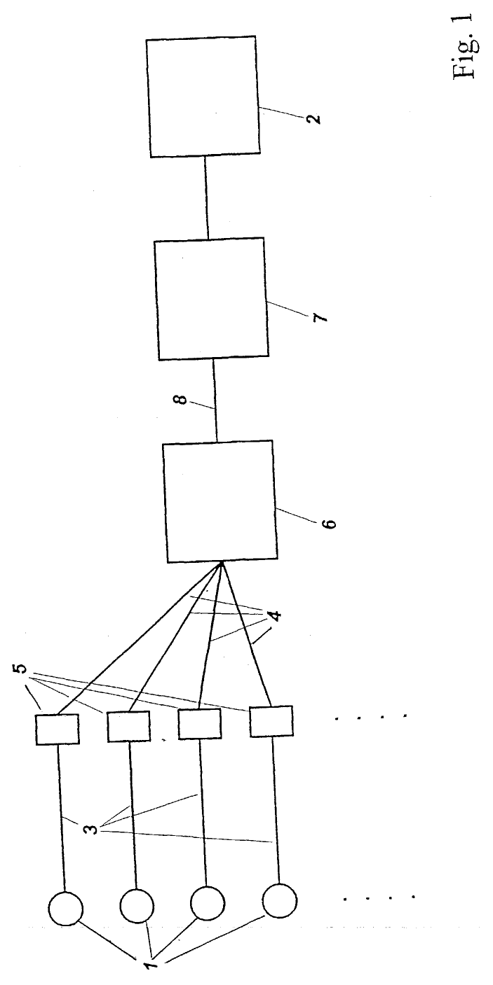

The object of the invention to devise a process and a device with which the disadvantages of the prior art are avoided and with which the measurement accuracy, the possible length of the measurement probes, the measurement speed and flexibility can be increased in multichannel measurement arrangements, is achieved by a process for measurement of temperatures by means of optical detection of energy band gaps of solids with electrical light sources, measurement probes and a wavelength-sensitive detection system that measures the frequency of the light guided back by the measurement probe, from a number of at least two light sources by means of a control unit, one or more light sources are turned on over defined time intervals, the light emitted by the light sources that have been turned on being routed, via the optical fibers assigned to the respective light source, to a solid-state sensor assigned to the light source in which the optical signal is modified depending on temperature, the modified optical signal being routed via optical fibers to an optical mixer, in which the modified optical signals of all solid-state sensors are combined, and the resulting optical signal being routed from the mixer to an optical detection system, in which the spectral properties of the optical signal are converted with time resolution into electrical signals, and from the time-resolved electrical signals, an evaluation unit calculating one or more temperatures that are assigned to the light sources and to the associate solid-state sensors (measurement channels).

### DESCRIPTION

The invention relates to a process and an arrangement for multichannel measurement of temperatures by means of optical detection of energy band gaps of solids as claimed in claims 1 and 6.

Possible applications of the invention are, among others, process measurement technology, especially in conjunction with microwave and radio wave applications, medical measurement technology and nuclear technology.

For temperature measurement under special physical conditions, especially in strong electromagnetic fields, in the presence of corrosive chemical substances or under radioactive radiation, optical measurement methods are known, mainly three methods being distinguished:

11. An interferometric process that uses the change of an optical light path when the temperature varies;

2. a measurement process that uses inelastic light scattering (Raman effect) in solids, especially of an optical fiber, and

3. a measurement process that evaluates the relative shift of the band edges of solids, generally of semiconductors, as a function of temperature.

The known process according to item 3 uses the relationships that exist between the energy of photons and the energy of electrons of a solid. If a photon striking a solid has enough energy to shift an electron into the excited state (excitation from the valency into the conduction band), it can be absorbed. Based on the unique relationship between the light frequency and photon energy (direct proportionality), a certain minimum frequency is necessary so that electron excitation can take place by light over the band gaps. The wavelength or frequency starting from which significant light absorption (associated with electronic band-band transition) occurs forms a material-specific quantity that becomes apparent in a spectrum and that is called the optical band edge.

The energy that is necessary to excite an electron from the valency into the conduction band is dependent on the temperature of-the pertinent substance (band gap as a function of temperature). With determination of the optical absorption edge, it is thus possible to draw conclusions about the temperature of a solid (e.g., of a GaAs crystal).

Known temperature measurement probes that use this principle consist of an optical fiber and a measurement crystal, the same fiber being used for routing the light back and forth (company publication “An Overview of Nortech FO Thermometer Technology” of the company Nortech Fibronic Inc., Canada, 1998). The arrangement works with a single light source that is mechanically switched between several measurement charnels (optical detection channels) to one measurement probe at a time in order to be able to meet the requirements of a practicable measurement regime with several temperature channels (more than 10).

This conventional arrangement has some disadvantages. On the one hand, the signal noise/background ratio of the light that is incident on the detector is relatively low, since reflection within the fiber over the entire fiber length has some influence as a noise signal. This makes numerical determination of the band edge as a computation basis for the measurement temperature for greater lengths of the measurement probe (distance between the measurement point and measurement device) difficult, faulty, and susceptible to error. Switching to the individual measurement channels, on the other hand, limits the measurement speed, the variability with respect to the sequence of measurement channels, and the measurement instant.

EP 000 65 30 A1 describes a fiber-optic temperature measurement device for single-channel measurement in which either at least two light sources (or filters) or two detectors (or filters) are used to obtain two separate frequency ranges. Measurement in two frequency ranges is necessary.

Therefore, the object of the invention is to devise a process and a device with which the disadvantages of the prior-art are avoided and with which the measurement accuracy, the possible length of the measurement probes, the measurement speed and flexibility, especially for multichannel measurement arrangements, can be increased.

The object is achieved as claimed in the invention by the features of claims 1 and 6. Accordingly, the process for measurement of temperatures by means of optical detection of energy band gaps of solids is provided with electrical light sources, measurement probes and a wavelength-sensitive detection system that measures the frequency of the light guided back by the measurement probe. From a number of at least two light sources by means of a control unit, one or more light sources are turned on over defined time intervals for different measurement channels, the light emitted by the light sources that have been turned on being routed, via the optical fibers assigned to the respective light source, to the solid-state sensor assigned to the light source in which the optical signal is modified depending on temperature, the modified optical signal being routed via optical fibers to an optical mixer in which the modified optical signals of all solid-state sensors are combined, and the resulting optical signal being routed from the mixer to an optical detection system in which the spectral properties of the optical signal are converted with time resolution into electrical signals, and from the time-resolved electrical signals, an evaluation unit calculating one or more temperatures that are assigned to the light sources and to the associated solid-state sensors (measurement channels).

The arrangement for temperature measurement by means of optical detection of energy band gaps of solids consists of electrical light sources, solid-state sensors with temperature-dependent absorption that are located in the area to be measured and that are used as measurement probes, and a wavelength-sensitive detection system that measures the frequency of the light guided back by the measurement probe, at least two light sources that can be electrically triggered individually being connected by means of one optical fiber at a time to the inputs of one fiber-optic transmission cell at a time, with outputs that are connected via optical fibers to an optical mixer and its output via an optical fiber to an optical detection system with an output that is connected to an evaluation unit/control unit, which, moreover, switches the electrically triggerable light sources.

Feasible embodiments of the invention are the subject matter of the subclaims.

In one feasible embodiment, the fiber-optic connection between the light source and the solid-state sensor is separated from the fiber-optic connection between the solid-state sensor and the detector.

The measurement probe, moreover, consists of a connection that supplies light to the solid-state sensor from the light source, of a solid-state sensor and of a separate connection that carries the light away from the solid-state sensor to the detector.

In multichannel measurement arrangements, each fiber-optic connection between the light source and solid-state sensor is assigned its own light source that can be individually triggered. The fiber-optic connections that lead away from the solid-state sensor are routed to an optical mixer that is permanently optically connected to the detection system, feasibly a spectrometer. Therefore, an opto-mechanical switch can be abandoned. Interrogation of the individual measurement channels is accomplished by the time-staggered triggering of the light sources and suitable evaluation of the detector signal.

Compared to systems known to date, much greater measurement accuracy is achieved with the approach as claimed in the invention; use of clearly longer measurement probes (up to 2 km) becomes possible, and in multichannel arrangements, a higher channel scanning rate can be achieved.

Conversely, in conventional arrangements, it has been found that optical backscattering of an individual fiber significantly reduces the signal-noise/background ratio of the measurement signal, by which numerical determination of the band edge as a computation basis for the measurement temperature becomes much more difficult and the length of the measurement probe is limited.

The invention will be detailed below using one embodiment. The pertinent drawing shows a measurement arrangement as claimed in the invention in the sole FIGURE.

The arrangement works with at least one electrical light source 1, at least one measurement probe 5 and a wavelength-sensitive detector that measures the spectrum of the light guided back by the measurement probe 5, the measurement probe 5 consisting of a solid-state sensor with temperature-dependent absorption, which is located in the area to be measured, and fiber-optic connections to the light source and to the detector.

LEDs 1 with an emission peak at 920 mm and with a half-value width of roughly 50 nm are used as the light source. A temperature range of roughly 150° C. is accommodated with these values when using gallium arsenide (GaAs) as the sensor material. The LEDs 1 are triggered individually by a control unit 2. They can be connected and disconnected very quickly so that in multichannel arrangements, a high scanning frequency can be achieved.

The sensors consist of two optical fibers 3, 4, each 50 m long, with a fiber cross section of 100 μm, which are optically connected to a gallium arsenide sensor crystal 5 in the transmission mode. Each optical fiber 3 is permanently assigned its own LED 1.

The ends of the optical fibers 4 that guide the light coming from the sensor crystal 5 are routed to an optical mixer 6. The mixer 6 consists of a light-scattering polymer. It is made spherical with a diameter of roughly 1 cm and optically couples the optical fibers 4 to the spectrometer 7. The connection between the mixer 6 and the spectrometer 7 takes place in turn with an optical fiber 8.

The mixer 6 is designed to equivalently combine the light signals from all optical fibers 4 of the connection sensor crystals 5, if necessary with toleration of line losses. With it, all measurement channels are switched simultaneously and permanently to the detector, here the spectrometer 7.

The spectrometer 7 feasibly consists of a CCD line and a permanently calibrated optical grating. It is designed for measurement in a wavelength range from 850 to 1100 nm. The emission spectrum that has been modified by the sensor crystal 5 is numerically evaluated with respect to the optical band edge, represented by an inflection point. Operation can be integrated in the control unit 2, under certain circumstances with a display.

Reference number list

| | |
|---|---|
| 1 | LED (light source) |
| 2 | control unit |
| 3 | optical fiber |
| 4 | optical fiber |
| 5 | solid-state sensor (sensor crystal) |
| 6 | optical mixer |
| 7 | spectrometer |
| 8 | optical fiber |

1. Process for multichannel temperature measurement by means of optical detection of energy band gaps of solids with electrical light sources, measurement probes and a wavelength-sensitive detection system that measures the frequency of the light guided back by the measurement probe, the light emitted by the light sources that have been turned on being routed, via the optical fiber assigned to the respective light source, to a solid-state sensor that is assigned to the light source in which the optical signal is modified depending on temperature, from a number of at least two light sources by means of a control unit, one or more light sources being turned on over defined time intervals for different measurement channels, the modified optical signals being routed via optical fibers to an optical mixer that is known in the art in which the modified optical signals of all solid-state sensors are combined,
the resulting optical signal being routed via separate optical fibers from the mixer to an optical detection system, in which the spectral properties of the optical signal are converted with time resolution into electrical signals, and
from the time-resolved electrical signals, an evaluation unit calculating one or more temperatures that are assigned to the light sources and to the associated solid-state sensors (measurement channels).

2. Process for temperature measurement as claimed in claim 1, wherein only one light source at a time is turned on in alternation.

3. Process for temperature measurement as claimed in claims 1 and 2, wherein the light sources are turned on periodically.

4. Process for temperature measurement as claimed in claim 1, wherein several light sources with different frequencies are turned on periodically.

5. Process for temperature measurement as claimed in claims 1 to 4, wherein the solid-state sensor works in the transmission and/or reflection and/or in the diffuse reflection mode.

6. Arrangement for temperature measurement by means of optical detection of energy band gaps of solids with electrical light sources (1), solid-state sensors (5) with temperature-dependent absorption that are located in the area to be measured and that are used as measurement probes, and at least one wavelength-sensitive detection system (7) that measures the frequency of the light guided back by the measurement probes, at least two light sources (1) that can be electrically triggered individually being connected by means of one optical fiber (3) at a time to the inputs of one fiber-optic transmission cell (5) at a time, with outputs that are connected via optical fibers to an optical mixer (6) and its output via an optical fiber (8) to an optical detection system (7) with an output that is connected to an evaluation unit/control unit (2) which, moreover, switches the electrically triggerable light sources (1).

7. Arrangement for temperature measurement as claimed in claim 6, wherein the light sources (1) are luminescence diodes with relatively large spectral bandwidth.

8. Arrangement for temperature measurement as claimed in one of claims 6 or 7, wherein the optical measurement probes are formed from one light-supplying and one light-removing optical fiber (3, 4) at a time, between which the solid-state sensor (5) with temperature-dependent optical absorption is located.

9. Arrangement for temperature measurement as claimed in one of the preceding claims, wherein the solid-state sensor (5) is an undoped semiconductor.

10. Arrangement for temperature measurement as claimed in claim 6, wherein the optical detection system (7) is a CCD line with a permanently calibrated optical grating.

11. Arrangement for temperature measurement as claimed in claim 6, wherein the optical detection system (7) is a spectrometer.

12. Arrangement for temperature measurement as claimed in claim 6, wherein the optical detection system (7) is formed from at least two photodiodes combined with optical filters.
